(19) United States
(12) Patent Application Publication
(10) Pub. No.: US 2026/0138177 A1
(43) Pub. Date: May 21, 2026

(54) METHOD OF PRODUCING JOINED BODY OF DIFFERENT MATERIALS

(71) Applicants: UACJ CORPORATION, Tokyo (JP); AOYAMA SEISAKUSHO CO., LTD., Aichi (JP)

(72) Inventors: Yutaro KONNO, Tokyo (JP); Kazuki AKATSUKA, Aichi (JP); Dan KITAJIMA, Aichi (JP); Kazuhiro KOGA, Aichi (JP)

(73) Assignees: UACJ CORPORATION, Tokyo (JP); AOYAMA SEISAKUSHO CO., LTD., Aichi (JP)

(21) Appl. No.: 18/869,787

(22) PCT Filed: May 25, 2023
(86) PCT No.: PCT/JP2023/019533

§ 371 Date: Sep. 29, 2025

(30) Foreign Application Priority Data
May 31, 2022 (JP) 2022-088558

(51) Int. Cl. B21J 15/02; B23K 11/11; B23K 11/20; B23K 11/34; B23K 103/10

(52) U.S. Cl. CPC B21J 15/025; B23K 11/115; B23K 11/20; B23K 11/34; B23K 2103/10

(57) ABSTRACT

According to a method of producing a joined body of different materials, pushing a rivet including a head portion and a stem portion that has a round columnar shape and projection portions and recessed portions on an outer peripheral surface into a first member, joining the first member and the projection portions and the recessed portions of the rivet, inserting the stem portion of the rivet through the first member, contacting the stem portion of the rivet that is inserted through the first member with a second member that is made of material different from material of the first member, and applying electric current between the head portion of the rivet and the second member with pressing and welding the rivet and the second member to form the joined body of different materials.

### TECHNICAL FIELD

The technology disclosed herein relates to a method of producing a joined body of different materials.

### BACKGROUND ART

A method of producing a joined body of different materials by joining two members of different materials has been known and one of such methods is described in Patent Document 1. In Patent Document 1, to strongly join a steel material and an aluminum alloy material, a steel rivet for joining the different materials is pushed into and fixed to the aluminum alloy material with clamping. The rivet and the steel material are sandwiched by a pair of electrodes and supplied with electric power and joined together with spot welding.

A head portion of the rivet described in Patent Document 1 has a groove in a lower surface thereof (a surface that overlaps the aluminum alloy material). With the rivet being pushed into the aluminum alloy material, the aluminum alloy material is plastically deformed and enters the groove. Accordingly, the rivet is fixed with clamping.

### RELATED ART DOCUMENT

Patent Document 1: Japanese Unexamined Patent Application Publication No. 2010-207898

### Problem to be Solved by the Invention

However, with the rivet having the groove in the lower surface of the head portion, melted aluminum alloy material may not flow into the groove effectively at the time of spot welding of the rivet and the steel. This may lower joint strength and cause variation in joint strength among multiple rivets. With the groove being formed, the current flow may be branched at the time of spot welding and a current may not be supplied to the target joint portion. This also may lower joint strength and cause unstable joint strength.

### DISCLOSURE OF THE PRESENT INVENTION

The present technology was made in view of the above circumstances. An object is to increase joint strength of a joined body of different materials and stabilize the joint strength.

### Means for Solving the Problem

<1> A method of producing a joined body of different materials includes pushing a rivet including a head portion and a stem portion that has a round columnar shape and projection portions and recessed portions on an outer peripheral surface into a first member, joining the first member and the projection portions and the recessed portions of the rivet, inserting the stem portion of the rivet through the first member, contacting the stem portion of the rivet that is inserted through the first member with a second member that is made of material different from material of the first member, and applying electric current between the head portion of the rivet and the second member with pressing and welding the rivet and the second member to form the joined body of different materials.
<2> In the method of producing a joined body of different materials according to <1>, the projection portions and the recessed portions are formed in an entire circumferential area of the outer peripheral surface of the stem portion.
<3> In the method of producing a joined body of different materials according to <1> or <2>, the projection portions and the recessed portions are formed at equal intervals.
<4> In the method of producing a joined body of different materials according to any one of <1> to <3>, the stem portion includes a first stem portion including the projection portions and the recessed portions and a second stem portion that does not include the projection portions and the recessed portions, and a diameter of the first stem portion is greater than a diameter of the second stem portion.
<5 > In the method of producing a joined body of different materials according to any one of <1> to <4>, with an electric current being applied between the rivet and the second member with pressure, current density of current flowing through the stem portion of the rivet is 397 MA/m² or greater and 597 MA/m² or smaller and surface pressure applied to the stem portion of the rivet is 119 MPa or greater and less than 279 MPa, the joined body of different materials that is solidified after the welding includes a weld nugget that is a cast structure that is metal joint of the rivet and the second member, the weld nugget has a height measured along an axial direction of the stem portion and a ratio of the height of the weld nugget to a whole height of the joined body of different materials is 0.34 or greater and less than 0.8, and the weld nugget has a length measured along a radial direction of the stem portion and a value obtained by dividing the length of the weld nugget by the height of the weld nugget is 1.7 or greater and less than 5.4.
<6> In the method of producing a joined body of different materials according to any one of <1> to <5>, each of the projection portions has a triangular prism shape.
<7> In the method of producing a joined body of different materials according to any one of <1> to <6>, the first member is made of aluminum or an aluminum alloy.

### Advantageous Effect of the Invention

According to the technology described herein, joint strength of a joined body of different materials can be increased and stabilized.

### BRIEF DESCRIPTION OF THE DRAWINGS

FIG. 1 is an enlarged cross-sectional view illustrating a portion of a joined body of different materials near a rivet according to a first embodiment.

FIG. 2 is a perspective view of the rivet.

FIG. 3 is a plan view of the rivet.

FIG. 4 is a side view of the rivet.

FIG. 5 is a cross-sectional view illustrating a pressing process.

FIG. 6 is a cross-sectional view illustrating the rivet pushed into a first member.

FIG. 7 is a cross-sectional view illustrating a welding process.

FIG. 8 is a cross-sectional view illustrating the rivet and the second member with current supply and pressure.

FIG. 9 is a perspective view illustrating a rivet according to Comparative Example 1.

FIG. 10 is a cross-sectional view taken along line A-A in FIG. 9.

FIG. 11 is a cross-sectional view illustrating the rivet of Comparative Example 1 being fixed with clamping to the second member.

FIG. 12 is a table illustrating evaluation results of the joined body of different materials according to Example 1.

FIG. 13 is a table illustrating evaluation results of the joined body of different materials according to Comparative Example 1.

FIG. 14 is a table illustrating evaluation results of a joined body of different materials according to Example 2.

FIG. 15 is a table illustrating evaluation results of the joined body of different materials according to Comparative Example 2.

### MODES FOR CARRYING OUT THE INVENTION

### first Embodiment

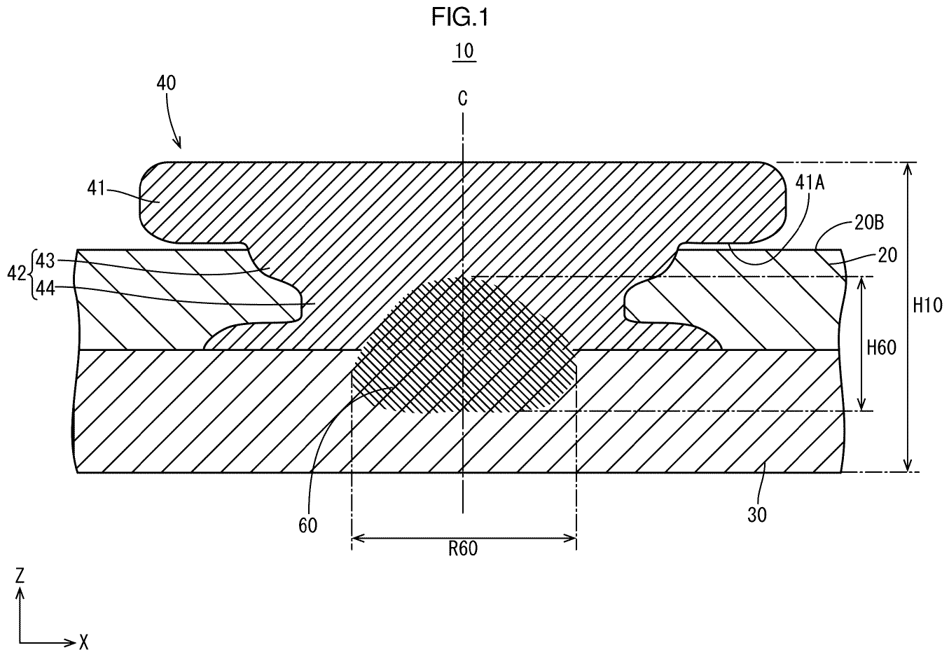

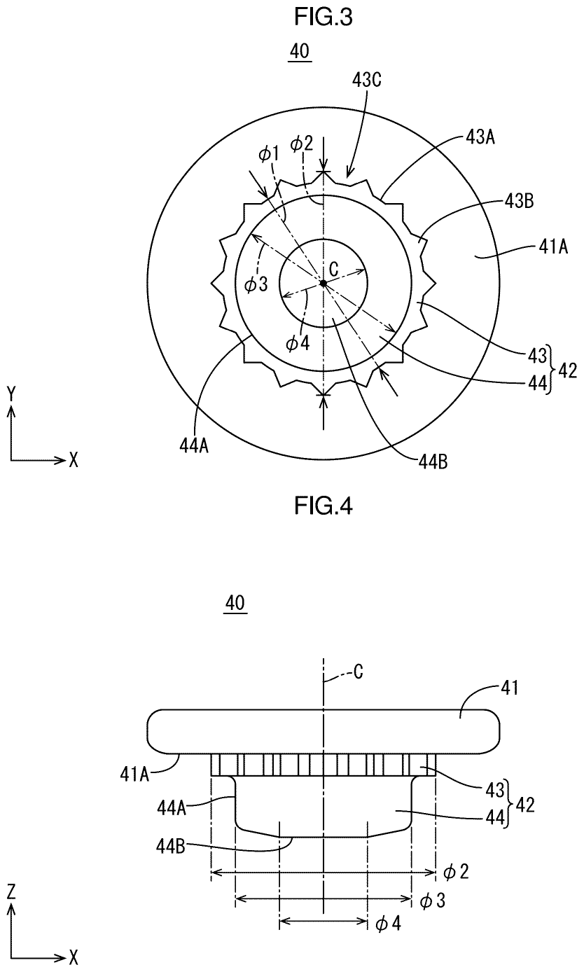

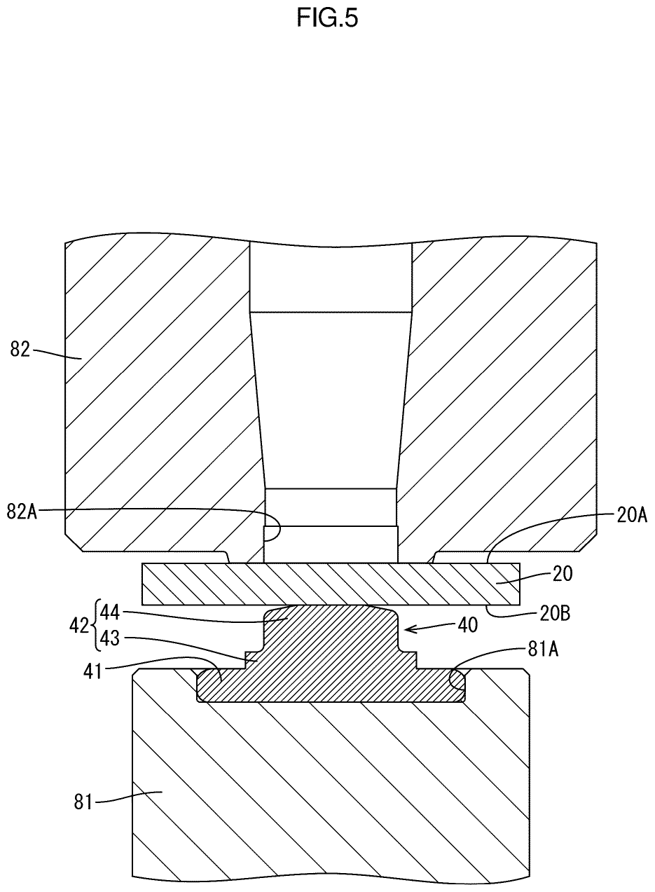

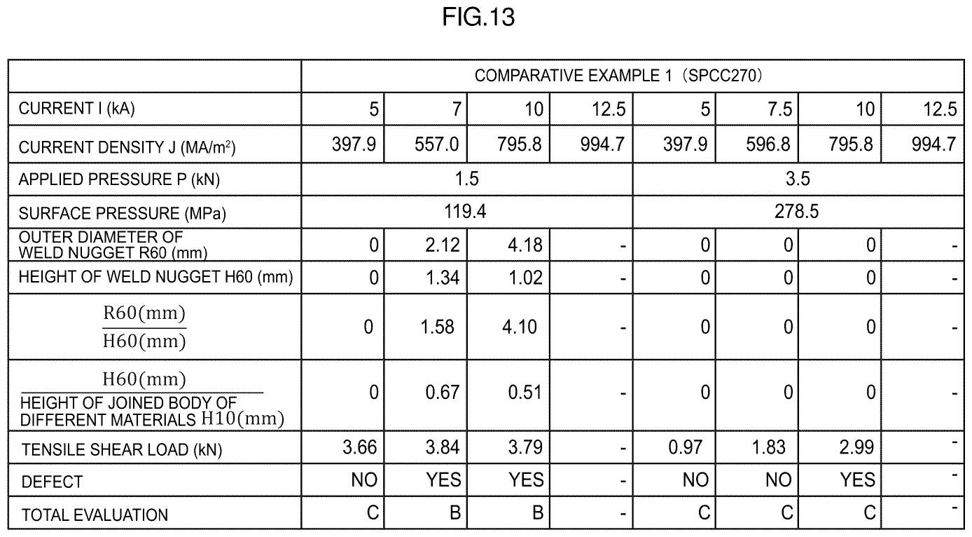

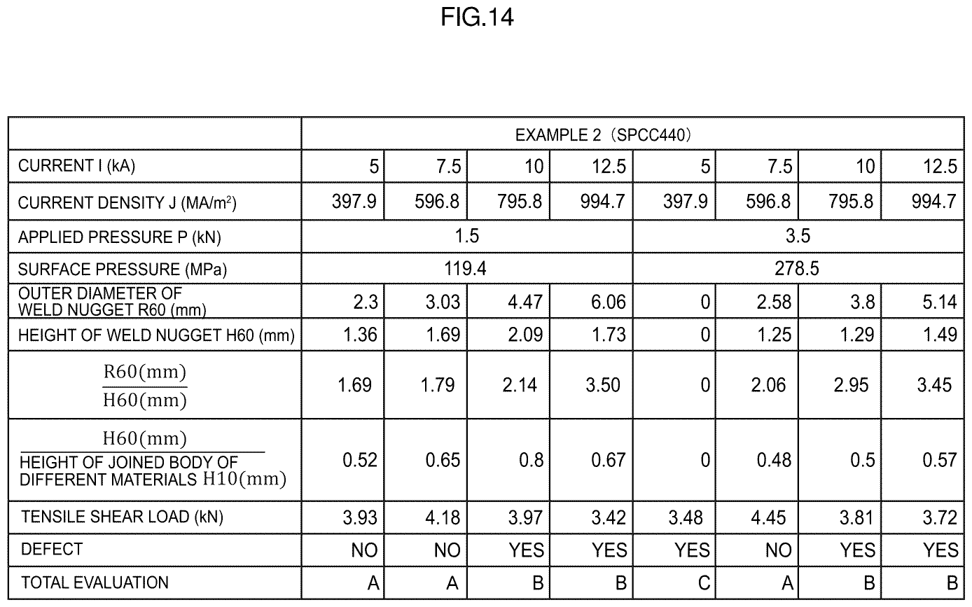

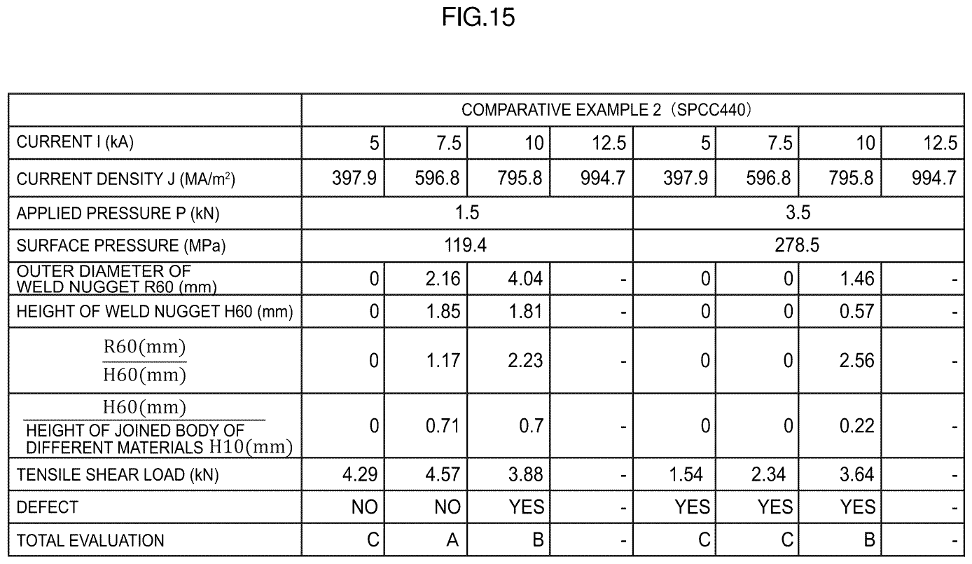

A joined body of different materials 10 and a method of producing the joined body of different materials 10 according to a first embodiment will be described with reference to FIGS. 1 to 15. An X-axis, a Y-axis and a Z-axis may be present in some of the drawings and each of the axial directions represents a direction represented in each drawing. A direction along the Z-axis corresponds to the upper-bottom direction. However, the direction is defined temporally and may not be limited thereto.

As illustrated in FIG. 1, the joined body of different materials 10 includes a fist member 20, a second member 30 that is made of different material from that of the first member 20, and a rivet 40 for joining the first member 20 and the second member 30. The joined body of different materials 10 is used for a panel structure of a vehicle, for example; however, it is not limited thereto. The rivet 40 is deformed during a process of producing the joined body of different materials 10 as will be described later. FIG. 1 illustrates the deformed rivet 40 that is included in the produced joined body of different materials 10.

The first member 20 is made of lightweight material. An example of the lightweight material is metal material such as aluminum and an aluminum alloy. The second member 30 is made of metal material that is greater in weight and strength than the first member 20. The second member 30 is made of steel generally used for a panel structure of a vehicle, for example. By overlapping the first member 20 and the second member 30 and producing the joined body of different materials 10, the strength can be ensured by the second member 30 and the reduction in weight can be achieved by the first member 20. With using material including aluminum as a main component for the first member 20, the joined body can be recycled easily. In this embodiment, the first member 20 and the second member are plate members; however, the shape of them is not limited to the plate shape. The first member 20 and the second member 30 are formed to have any shape as long as at least portions thereof can be overlapped. For example, the first member 20 and the second member 30 may have a tubular shape.

Generally, with the first member 20 and the second member 30 made of different materials being just overlapped and joined with spot welding, a fragile compound is created at an interface between the first member 20 and the second member 30 and the first member 20 and the second member 30 cannot be joined appropriately. In this respect, the joined body of different materials 10 includes the rivet 40 for joining the first member 20 and the second member 30. The rivet 40 is made of the same material as the metal material of the second member 30 (steel, for example) or the metal material including a same main component as that of the metal material of the second member 30 (iron, for example). As will be described later, at the interface between the rivet 40 and the second member 30, a cast structure (a weld nugget 60 described later) that is highly strong metal joint is created by welding.

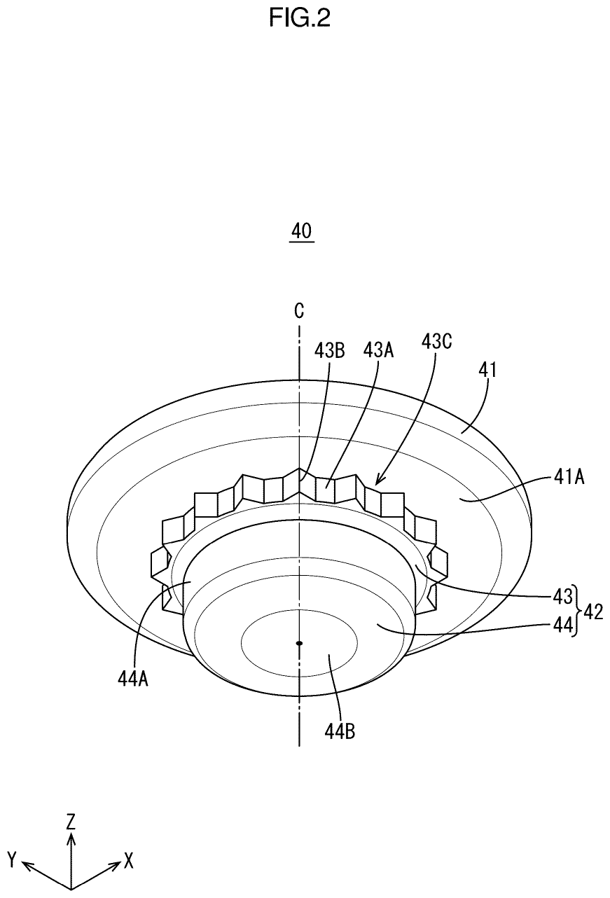

As illustrated in FIGS. 2 to 4, the rivet 40 includes a head portion 41 having a disk shape and a stem portion 42 that extends from one surface 41A (a first surface) of the head portion 41 and has a substantially round columnar shape. The rivet 40 has a cross-sectional shape of a T-shape as a whole and includes integrally formed portions. The stem portion 42 and the head portion 41 are coaxially formed and have a same center axis C. An outer diameter of the stem portion 42 is smaller than that of the head portion 41. The stem portion 42 includes a first stem portion 43 on the head portion 41 side (at an extending basal end) and a second stem portion 44 that is on an opposite side from the head portion 41 (at an extending distal end). The stem portion 42 has a length extending along the center axis C (a length extending in the Z-direction) that is equal to or greater than that of a thickness (a length extending in the Z-direction) of the first member 20. With such a configuration, the stem portion 42 can pass through the first member 20 as will be described later.

As illustrated in FIGS. 2 to 4, the first stem portion 43 is between the head portion 41 and the second stem portion 44 and has an outer peripheral side surface 43A that is an uneven surface. The first stem portion 43 includes projection portions 43B on the outer peripheral side surface 43A over an entire area with respect to the circumferential direction. The projection portions 43B (sixteen in this embodiment) are arranged at equal intervals and project from the outer peripheral side surface 43A in a radial direction (a direction crossing the center axis C). The projection portions 43B have a triangular prism shape. Portions between the adjacent projection portions 43B that are arranged at equal intervals are recessed. With such a configuration, recessed portions 43C are formed at equal intervals. The first stem portion 43 has a diameter (an outer diameter dimension) that includes a smallest value Φ1 in a portion including the recessed portion 43C and a greatest value Φ2 in a portion including the projection portion 43B.

As illustrated in FIGS. 2 to 4, the second stem portion 44 extends from the first stem portion 43 toward an opposite side from the head portion 41. The second stem portion 44 has an outer peripheral side surface 44A that is not an uneven surface unlike the first stem portion 43. A greatest value Φ3 of a diameter of the second stem portion 44 is smaller than the smallest value Φ1 of the outer shape of the first stem portion 43. A distal end 44B (an extending end) of the second stem portion 44 has a circular surface having a diameter Φ4. A corner portion between the outer peripheral side surface 44A of the second stem portion 44 and the distal end 44B is sloped gently and has a round shape. The distal end 44B is tapered end and the diameter Φ4 of the distal end 44B of the second stem portion 44 is smaller than the diameter Φ3 of a body of the second stem portion 44.

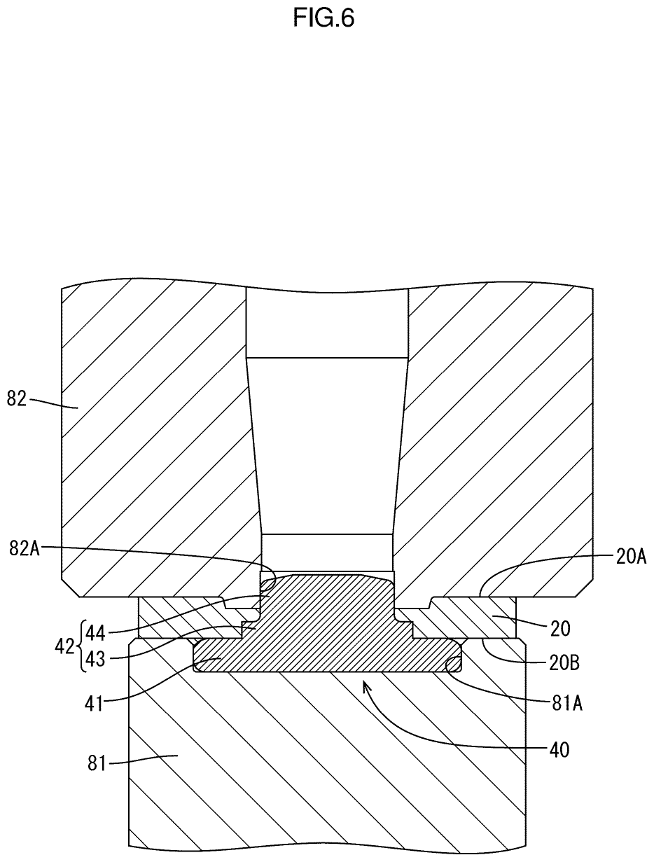

Next, a method of producing the joined body of different materials 10 will be described. The method includes a pressing process and a welding process performed after the pressing process. In the pressing process, as illustrated in FIGS. 5 and 6, a pressing device including a punch 81, which is a support member, and a dice 82, which is pressing means, is used. The punch 81 includes a recessed portion 81A on an upper surface and the recessed portion 81A has a shape and a size corresponding to the head portion 41 of the rivet 40. The dice 82 includes a hole 82A in which the second stem portion 44 can enter. First, in the pressing process, as illustrated in FIG. 5, the head portion 41 of the rivet 40 is placed in the recessed portion 81A of the punch 81. Then, the first member 20 is disposed between the second stem portion 44 of the rivet 40 and the dice 82 (FIG. 5) and pressure is applied to the dice 82 with the first member 20 being held therebetween (FIG. 6). Thus, the rivet 40 is pushed into the first member 20. Broken pieces of the first member 20 generated in the pressing process are removed in FIG. 6.

As illustrated in FIG. 6, the stem portion 42 (the first stem portion 43 and the second stem portion 44) of the rivet 40 is pushed into the first member 20 and the distal end 44B of the second stem portion 44 is inserted through the first member 20. With the strength (rigidity) of the material of the first member 20 being smaller than that of the rivet 40, the first member 20 is plastically deformed by the stem portion 42 that is pushed into the first member 20. The projection portions 43B and the recessed portions 43C of the second stem portion 44 are pressed and fitted into the first member 20 by pushing and fixed to the first member 20 with clamping. Each of the projection portions 43B projects and has a triangular prism shape and the projecting end is pointed sharply. Therefore, the projection portions 43B can be fitted into the first member 20 easily. The projection portions 43B and the recessed portions 43C are formed at equal intervals in an entire area of the outer peripheral side surface 43A along the circumferential direction. Therefore, the projection portions 43B and the recessed portions 43C are fixed with clamping to the first member 20 uniformly with respect to the circumferential direction.

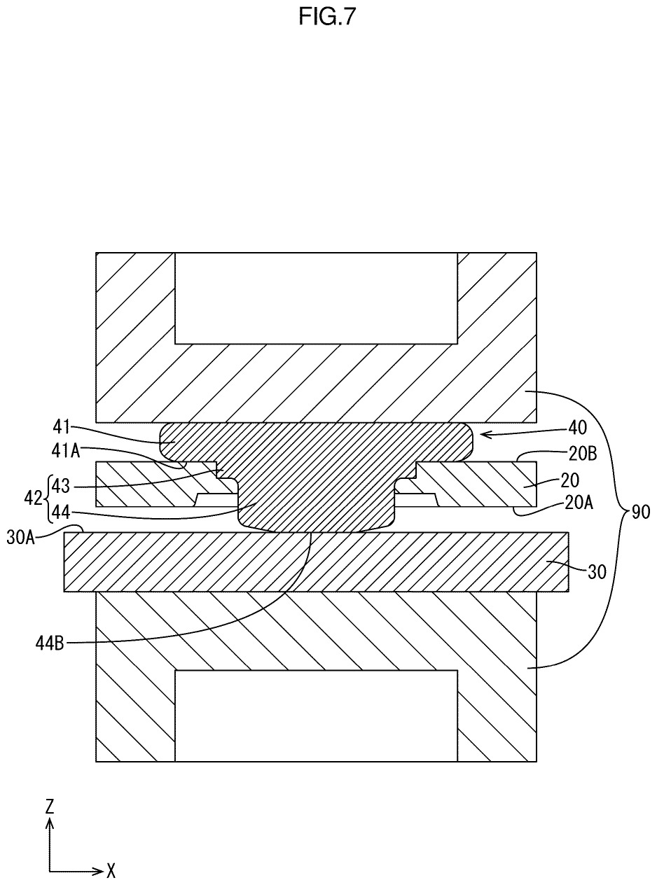

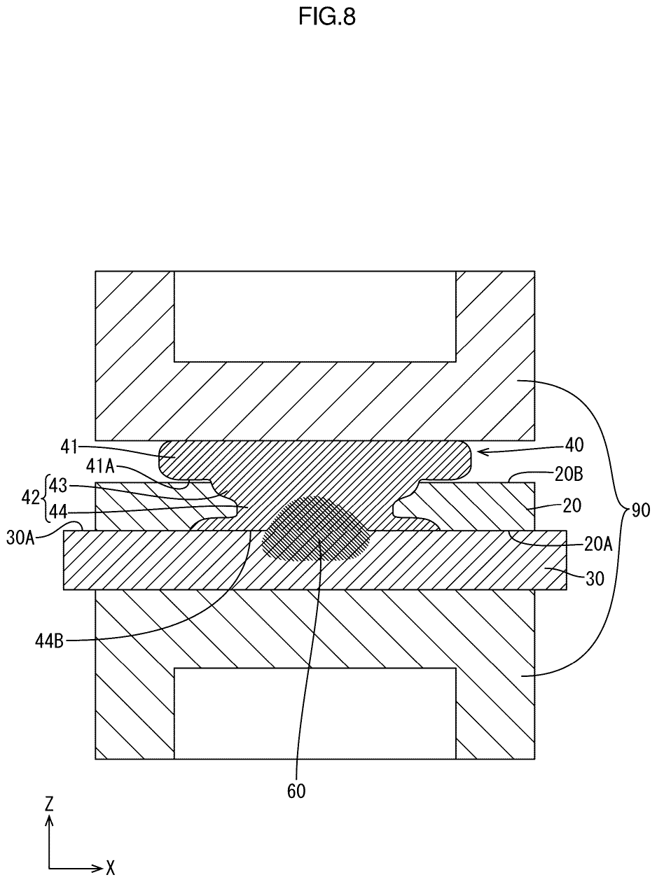

After pushing the rivet 40 into the first member 20 and fixing them with clamping in the pressing process, the welding process is performed as illustrated in FIG. 7. In the welding process, the first member 20 where the rivet 40 is pushed is placed on the second member 30 such that the distal end 44B of the second stem portion 44 of the rivet 40 is contacted with a first surface 30A (a surface facing the first member 20) of the second member 30. Then, the rivet 40, the first member 20, and the second member 30 are disposed between a pair of electrodes 90 and a voltage is applied. Thus, electric power is applied between the head portion 41 of the rivet 40 and the second member 30 with pressure. Accordingly, pressure force P is applied to a structure between the electrodes 90 and a current I flows between the electrodes 90 in the upper-bottom direction along the Z-direction. As a result, heat is generated by a resistance at an interface between the distal end 44B of the rivet 40 and the first surface 30A of the second member 30, that is, a contact portion of the rivet 40 and the second member 30. Accordingly, as illustrated in FIG. 8, the interface is melted and the rivet 40 and the second member 30 are joined with spot welding (resistance welding). The distal end 44B of the second stem portion 44 of the rivet 40 is melted due to the current supply with pressure and deformed. The distal end 44B is deformed to spread in a wide range on the first surface 30A as if being pressed by the second member 30. The weld nugget 60 that is a cast structure of joined metal is formed in the contact portion of the rivet 40 and the second member 30. As illustrated in FIG. 1, the joined body of different materials 10 that is solidified after the welding includes the weld nugget 60 having a height (a length extending along the center axis C) H60 and an outer diameter R60 (a length extending along a radial direction that crosses the center axis C).

with the first member 20 being melted due to the current supply with pressure, the melted material moves to fill spaces between the projection portions 43B and the recessed portions 43C. With the projection portions 43B and the recessed portions 43C being formed at equal intervals in an entire circumferential area of the outer peripheral side surface 43A, the first member 20, which is melted, moves to fill the spaces in the entire circumferential area. Accordingly, the first member 20, which is melted, easily flows into the recessed portions 43C, which are grooves of the rivet 40, and the spaces between the first member 20 and the rivet 40 are filled with the melted material. This improves joint strength.

With the stem portion 42 of the rivet 40 being melted due to the current supply with pressure and pressed, a portion of the head portion 41 of the rivet 40 that is continuous to the stem portion 42 moves slightly toward the first member 20 (downward). Accordingly, as illustrated in FIG. 8, the peripheral portion of the head portion 41 is slightly away from the first member 20. A small space is created between the first surface 41A of the head portion 41 and a surface 20B (an opposite surface from a surface facing the second member 30 between surfaces 20A, 20B) of the first member 20. As a result, a current flowing between the electrodes 90 is likely to flow to the stem portion 42 of the rivet 40. Therefore, a current is likely to flow to the contact portion where the distal end 44B of the rivet 40 and the first surface 30A of the second member 30 are contacted with each other and that is to be joined with spot welding. If the first surface 41A of the head portion 41 is contacted with the surface 20B of the first member 20, the current flowing between the electrodes 90 is also likely to flow to the contact portion of the head portion 41 and the first member 20. This reduces the current flowing through the distal end 44B of the rivet 40 and the first surface 30A of the second member 30. Heat generated by a resistance and the melting may be insufficient and the joint strength may be lowered and become unstable. In this embodiment, insufficient melting due to the current flowing through an unexpected portion is less likely to occur and the joint strength of the joined body of different materials 10 can be improved and stabilized.

The current I flowing between the electrodes 90 in the spot welding is adjusted as appropriate according to the material of the rivet 40 and the second member 30. If the current I is too small, the heat generated by a resistance is insufficient and the weld nugget 60 may not be formed. If the current I is too large, expulsion may occur and quality of the joined body of different materials 10 may be lowered. The current density of the current I flowing between the electrodes 90 is preferably in the range from 430 (MA/m²) to 517 (MA/m²).

To evaluate the performance of the joined body of different materials 10, Comparative Experiment 1 was performed. In Comparative Experiment 1, joined bodes of different materials of Examples 1 and 2 and Comparative Examples 1 and 2 were produced and evaluated. Examples 1 and 2 are evaluation samples of the joined body of different materials 10 described above. Comparative Examples 1 and 2 are evaluation samples of a joined body of different materials 910 produced with the same method of producing the joined body of different materials 10 and using a rivet 940 having a shape different from that of the first embodiment.

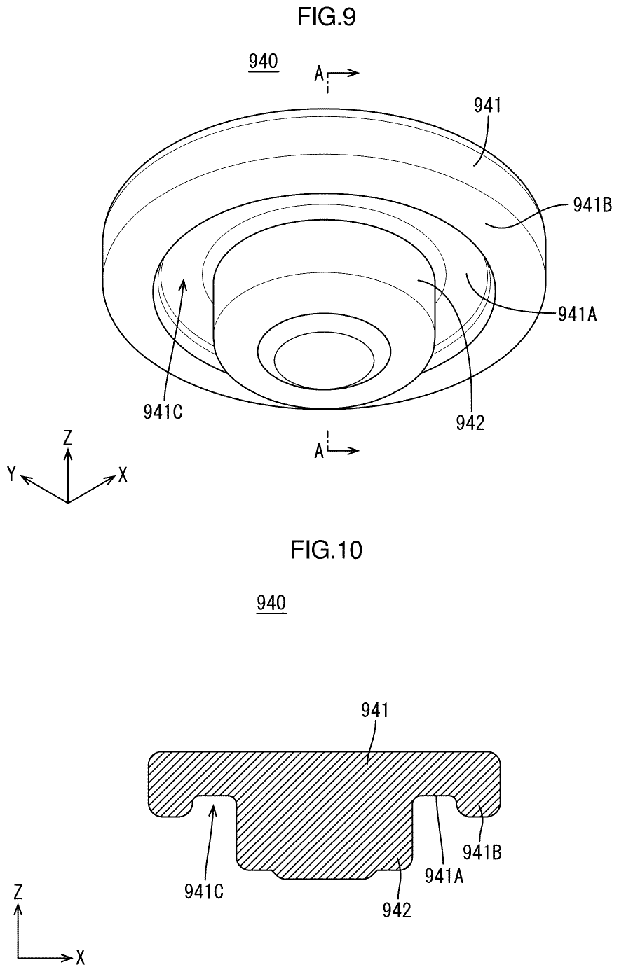

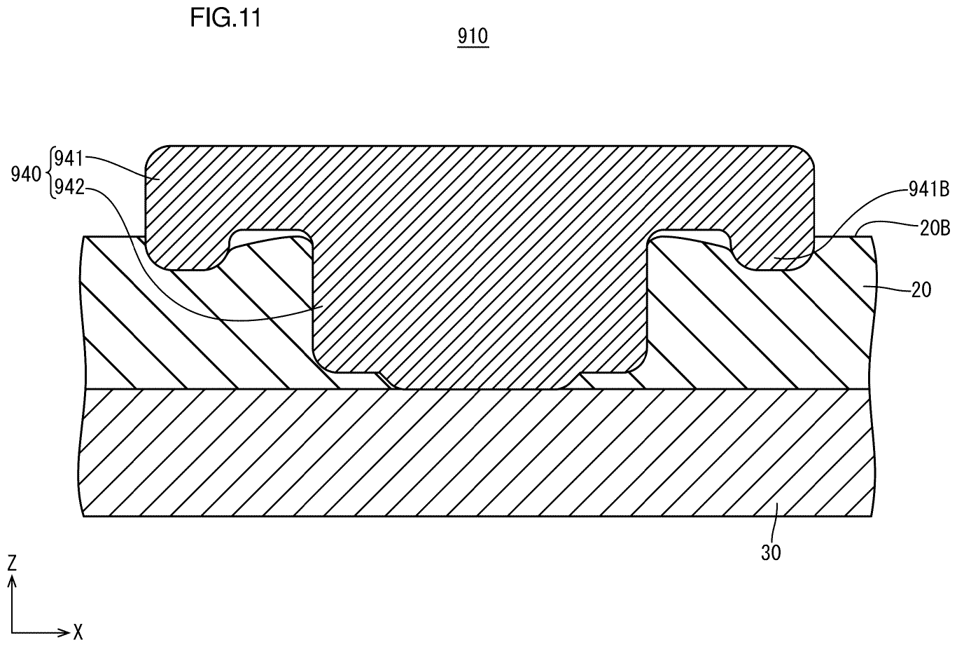

As illustrated in FIGS. 9 and 10, the rivet 940 of the joined body of different materials 910 of Comparative Examples 1 and 2 includes a head portion 941 having a disk shape and a stem portion 942 that extends from a first surface 941A of the head portion 941 and has a substantially round columnar shape. Unlike the rivet 40 of the first embodiment, the stem portion 942 does not include the first stem portion 43 having an uneven outer peripheral side surface. An outer peripheral portion 941B of the head portion 941 of the rivet 940 projects downward along the center axis C from the first surface 941A. A ring-shaped groove 941C is formed between the outer peripheral portion 941B and the stem portion 942.

With the rivet 940 being pushed into the first member 20, as illustrated in FIG. 11, the first member 20 is plastically deformed and enters the groove 941C and the rivet 940 is fixed with clamping to the second member 30. Then, with welding being performed by current supply with pressure, the first member 20 moves into the groove 941C. The movement of the first member 20 into the groove 941C is not as easy as the case using the rivet 40 of the above embodiment. The space between the first member 20 and the rivet 940 may not be sufficiently filled with the first member 20. If the stem portion 942 is melted and pressed and pushed into the first member 20 (downward), the outer peripheral portion 941B, which projects downward, keeps in contact with the surface 20B of the first member 20 and current is likely to flow through the contact portion.

### Conditions

The first member 20: aluminum plate
Thickness of the first member 20:1.2 (mm)
The second member 30: steel plate (JIS SPCC 270 in Example 1 and Comparative Example 1, JIS SPCC 440 in Example 2 and Comparative Example 2)
Thickness of the second member 30:0.8 (mm) in Example 1 and Comparative Example 1, 1.4 (mm) in Example 2 and Comparative Example 2
Material of the rivet 40 and the rivet 940: steel
Diameter Φ3 of the rivet 40 and a diameter of the stem portion 942 of the rivet 940: 4 (mm)
Applied pressure P: 1.5 (kN) or 3.5 (kN)
Current I: 5 (kA) or more and 12.5 (kA) or less in Examples 1 and 2, 5 (KA) or more and 10 (kA) or less in Comparative Examples 1 and 2

### Evaluation Method

With respect to Examples 1, 2 and Comparative Examples 1, 2, the tensile shear test and defect check (defects such as interfacial separation, crushing of the rivet, a blowhole) were performed, appropriate formation of the weld nugget 60 was checked, and a size of the weld nugget 60 was measured. In the tensile shear test, the first member 20 and the second member 30 of each of the joined bodies of different materials are pulled in opposite directions with respect to the direction crossing the center axis C and a tensile load at the time of occurrence of shear deformation was measured. As the measured tensile load is greater, it can be evaluated that the joint strength is greater. With respect to the defect check, the outer appearance of each of the joined bodies of different materials was observed to check whether interfacial separation, crushing of the rivet, and a blowhole are caused. With any defect being caused, the result is YES and with no defect being caused, the result is NO. With respect to checking of appropriate formation of the weld nugget 60 and measurement of a size of the weld nugget 60, each of the joined bodies of different materials is corroded with picric acid and polished and an exposed cross-sectional surface including the center axis C was observed with a microscope. With the weld nugget 60 being formed, it can be evaluated that the spot welding was appropriately performed and furthermore, the height H60 and the outer diameter R60 (FIG. 1) of the weld nugget 60 were measured. A ratio of the height H60 and the outer diameter R60 (R60/H60) and a ratio of the height H60 to a height H10 of each of the joined bodies of different materials (R60/H10) were calculated. The results of the tensile shear test, the defect check, and the formation of the weld nugget 60 were totally evaluated and are classified into three levels of A (good), B (not bad), C (bad).

### [Evaluation Results]

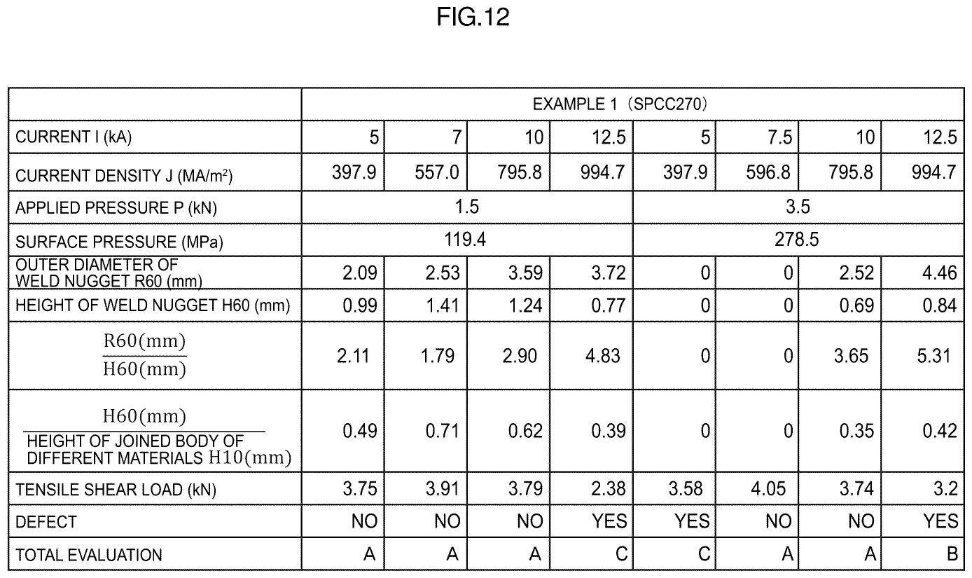

Evaluation results of Comparative Experiment 1 will be described in tables in FIGS. 12 to 15. It was confirmed that in Examples 1 and 2, the range of the current I and applied pressure P that can be used for the welding is wider than Comparative Examples 1 and 2 and the joint strength can be improved and stabilized. In Examples 1 and 2, with the current density J, which represent a current flowing through the stem portion 42 of the rivet 40, being in the range of 397 (MA/m²) or greater and 597 (MA/m²) or smaller, and with a surface pressure that is obtained by dividing the cross-sectional area of the stem portion 42 of the rivet 40 by the applied pressure P being in the range of 119 MPa or greater and less than 279 MPa, the weld nuggets 60 are appropriately formed. Specifically, it is evaluated that the weld nugget 60 is appropriately formed with the value of H60/H10 being 0.34 or greater and less than 0.8 and with the value of R60/H60 being 1.7 or greater and less than 5.4.

### Other Embodiments

The technology disclosed in this specification is not limited to the embodiment described in the above and the drawings but the embodiment may be altered as appropriate.
(1) The shape, the size, and the intervals of the projection portions 43B and the recessed portions 43C of the rivet 40 are not limited to those illustrated in the drawings but may be altered as appropriate.
(2) The projection portions 43B and the recessed portions 43C of the rivet 40 may not be formed in the entire circumferential area of the outer peripheral side surface 43A.
(3) The first member 20 may not be made of metal material but may be made of lightweight material such as carbon fiber reinforced plastics.

### EXPLANATION OF SYMBOLS

10: joined body of different materials, 20: first member, 30: second member, 40: rivet, 41: head portion, 42: stem portion, 43: first stem portion, 44: second stem portion, 43A: outer peripheral side surface (outer peripheral surface), 43B: projection portion, 43C: recessed portion, 60: weld nugget

1. A method of producing a joined body of different materials comprising:
pushing a rivet including a head portion and a stem portion that has a round columnar shape and projection portions and recessed portions on an outer peripheral surface into a first member such that the projection portions and the recessed portions of the rivet and the first member are joined and the stem portion of the rivet is inserted through the first member;
contacting the stem portion of the rivet that is inserted through the first member with a second member that is made of material different from material of the first member; and
applying electric current between the head portion of the rivet and the second member with pressing and welding the rivet and the second member to form the joined body of different materials.

2. The method of producing a joined body of different materials according to claim 1, wherein the projection portions and the recessed portions are formed in an entire circumferential area of the outer peripheral surface of the stem portion.

3. The method of producing a joined body of different materials according to claim 1, wherein the projection portions and the recessed portions are formed at equal intervals.

4. The method of producing a joined body of different materials according to claim 1, wherein
the stem portion includes a first stem portion including the projection portions and the recessed portions and a second stem portion that does not include the projection portions and the recessed portions, and
a diameter of the first stem portion is greater than a diameter of the second stem portion.

5. The method of producing a joined body of different materials according to claim 1, wherein
with an electric current being applied between the rivet and the second member with pressure, current density of current flowing through the stem portion of the rivet is 397 MA/m² or greater and 597 MA/m² or smaller and surface pressure applied to the stem portion of the rivet is 119 MPa or greater and less than 279 MPa,
the joined body of different materials that is solidified after the welding includes a weld nugget that is a cast structure that is metal joint of the rivet and the second member,
the weld nugget has a height measured along an axial direction of the stem portion and a ratio of the height of the weld nugget to a whole height of the joined body of different materials is 0.34 or greater and less than 0.8, and
the weld nugget has a length measured along a radial direction of the stem portion and a value obtained by dividing the length of the weld nugget by the height of the weld nugget is 1.7 or greater and less than 5.4.

6. The method of producing a joined body of different materials according to claim 1, wherein each of the projection portions has a triangular prism shape.

7. The method of producing a joined body of different materials according to 1, wherein the first member is made of aluminum or an aluminum alloy.
